(19) United States
(12) Patent Application Publication
(10) Pub. No.: US 2015/0036088 A1
(43) Pub. Date: Feb. 5, 2015

(54) LIQUID CRYSTAL DISPLAY

(71) Applicant: SAMSUNG DISPLAY CO., LTD, Yongin-City (KR)

(72) Inventors: Hyung Guen YOON, Gyeonggi-do (KR); Soon Joon RHO, Gyeonggi-do (KR); Hye Lim JANG, Gyeonggi-do (KR)

(73) Assignee: SAMSUNG DISPLAY CO., LTD, Yongin-City (KR)

(21) Appl. No.: 14/187,894

(22) Filed: Feb. 24, 2014

(30) Foreign Application Priority Data
Jul. 30, 2013 (KR) 10-2013-0090210

(51) Int. Cl. G02F 1/1333; G02F 1/1343

(52) U.S. Cl. CPC G02F 1/133345; G02F 1/1343
USPC 349/106; 349/139; 349/138; 349/123

(57) ABSTRACT

A liquid crystal display includes an interval layer to reduce a cell gap between a lower substrate and an upper substrate. A first electrode is disposed on the lower substrate. The interval layer covers on the first electrode. A second electrode is disposed on the upper substrate and facing the lower electrode. A liquid crystal layer including a liquid crystal material is interposed between the interval layer and the second electrode. The first electrode includes repetitively patterned electrodes.

### CROSS-REFERENCE TO RELATED APPLICATION

This application claims priority under 35 U.S.C. 119 to Korean Patent Application No. 10-2013-0090210, filed on Jul. 30, 2013 in the Korean Intellectual Property Office, the disclosure of which are incorporated herein by reference in its entirety.

### TECHNICAL FIELD

The present invention relates to a liquid crystal display.

### DISCUSSION OF RELATED ART

Liquid crystal displays (LCDs) include liquid crystal molecules whose major axes are rotated according to an electric field applied to the LCDs. The rotated liquid crystal molecules may direct light from a backlight to the screens of LCDs, controlling the amount of the light, to display an image. The directed light may lead to a narrow view angle.

### SUMMARY

According to an exemplary embodiment of the present invention, a liquid crystal display includes an interval layer to reduce a cell gap between a lower substrate and an upper substrate. A first electrode is disposed on the lower substrate. The interval layer covers on the first electrode. A second electrode is disposed on the upper substrate and facing the lower electrode. A liquid crystal layer including a liquid crystal material is interposed between the interval layer and the second electrode. The first electrode includes repetitively patterned electrodes.

A sum of a thickness of the liquid crystal layer and a thickness of the interval layer may corresponds to a distance between the first electrode and the second electrode.

The interval layer may comprise an insulating material.

The first electrode may comprise a fine slit-shaped electrode and the second electrode comprises a plate-shaped electrode.

The first electrode may comprise a cross stem part which comprises a horizontal stem part and a vertical stem part intersecting the horizontal stem part and the cross stem part is comprised in a unit pixel region.

The first electrode may comprise a plurality of fine branch parts extending in different directions from the horizontal and the vertical stem parts.

The first electrode may comprise a transparent conductive material.

The interval layer may comprise an insulating material and has a refractive index ranging about 1.6 and about 1.8.

The refractive index of the interval layer may be substantially the same as that of the first electrode.

A dielectric constant of the interval layer may be substantially equal to or larger than that of the liquid crystal material.

A major axis of the liquid crystal material may be aligned in a direction substantially vertical to the upper substrate or the lower substrate if no electric field between the first electrode and the second electrode is applied.

The liquid crystal material may have a negative dielectric anisotropy.

The liquid crystal display further comprises a color filter disposed between the lower substrate and the first electrode.

The liquid crystal display further comprises an alignment layer disposed between the interval layer and the liquid crystal layer.

At least one of the alignment layer and the liquid crystal layer may include an alignment polymer.

The liquid crystal display further comprises a thin film transistor formed on the lower substrate and configured to provide a data voltage to the first electrode.

According to an exemplary embodiment of the present invention, a liquid crystal display includes a plurality of pixels. At least one pixel includes a first electrode including repetitively patterned electrodes and disposed on a lower substrate, an interval layer covering the first electrode, and a second electrode disposed on an upper substrate and facing the lower electrode. Each pixel further includes a pair of alignment layers disposed on inner surfaces defined between the second electrode and the interval layer and a liquid crystal layer including a plurality of liquid crystal molecules and interposed between the pair of alignment layers. A data voltage is supplied to the first electrode and a common electrode is supplied to the second electrode to generate an electric field between the first electrode and the second electrode.

The interval layer may be formed of an insulating material, wherein a dielectric constant of the interval layer is substantially equal to or larger than a dielectric constant of the liquid crystal layer.

The repetitively patterned electrodes of the first electrode is grouped into at least two groups according to an direction along which patterned electrodes are extended, wherein a first group of the at least two groups has a first direction and a second group of the at least two groups has a second direction substantially perpendicular to the first direction.

At least one of the liquid crystal layer and the alignment layers includes alignment polymers.

### BRIEF DESCRIPTION OF THE DRAWINGS

These and other features of the present invention will become more apparent by describing in detail exemplary embodiments thereof with reference to the accompanying drawings of which:

FIG. 1 is a circuit diagram of a pixel of a liquid crystal display according to an exemplary embodiment of the present invention;

FIG. 2 is a layout view of a liquid crystal display according to an exemplary embodiment of the present invention;

FIG. 3 is a cross-sectional view taken along line III-III′ of FIG. 2;

FIG. 4 is a top plan view of a pixel electrode according to an exemplary embodiment of the present invention;

FIG. 5 is a top plan view of a basic electrode of a liquid crystal display according to an exemplary embodiment of the present invention;

FIGS. 6A and 6B are schematic diagrams illustrating a method of forming a pretilt of a liquid crystal according to an exemplary embodiment of the present invention; and

FIGS. 7 and 8 are photographs of screens driven by a liquid crystal display according to an exemplary embodiment of the present invention.

### DETAILED DESCRIPTION OF THE EMBODIMENTS

Exemplary embodiments of the present invention will be described below in detail with reference to the accompanying drawings. However, the present invention may be embodied in different forms and should not be construed as limited to the embodiments set forth herein. In the drawings, the thickness of layers and regions may be exaggerated for clarity. It will also be understood that when an element is referred to as being “on” another element or substrate, it may be directly on the other element or substrate, or intervening layers may also be present. It will also be understood that when an element is referred to as being “coupled to” or “connected to” another element, it may be directly coupled to or connected to the other element, or intervening elements may also be present. Like reference numerals may refer to the like elements throughout the specification and drawings.

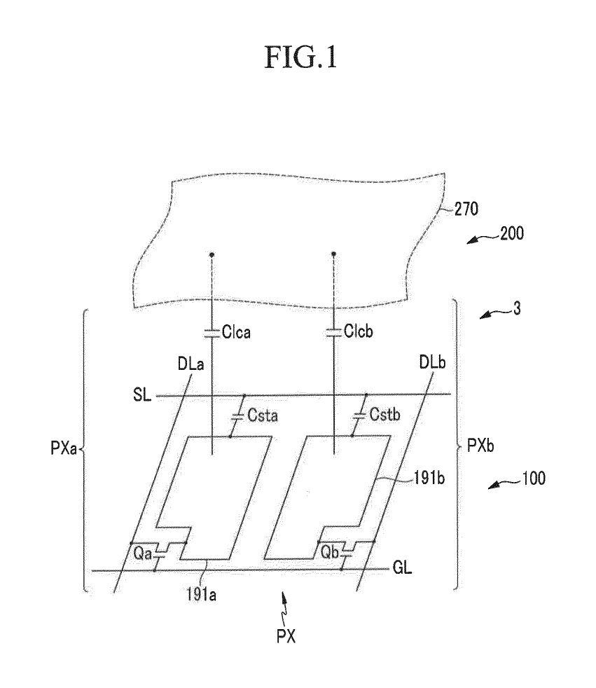

FIG. 1 is a circuit diagram of a pixel of a liquid crystal display according to an exemplary embodiment of the present invention.

Referring to FIG. 1, the liquid crystal display includes a thin film transistor array panel 100, a common electrode panel 200, and a liquid crystal layer 3. The liquid crystal layer 3 is interposed between the thin film transistor array panel 100 and the common electrode panel 200.

The liquid crystal display includes signal lines and a plurality of pixels PXs connected thereto. The signal lines include a plurality of gate lines GLs, a plurality of pairs of data lines DLa and DLb, and a plurality of storage electrode lines SLs.

Each of the pixels PXs includes a pair of subpixels PXa and PXb. The subpixel PXa includes a switching element Qa, a liquid crystal capacitor Clca, and a storage capacitor Csta. The subpixel PXb includes a switching element Qb, a liquid crystal capacitor clcb, and a storage capacitor cstb.

The switching elements qa and Qb are a three terminal element, such as a thin film transistor, included in the lower panel 100, and control terminals of thereof are connected to the gate line GL, input terminals thereof are connected to the data lines DLa and DLb, and output terminals thereof are connected to the liquid crystal capacitors clca and Clcb and the storage capacitors csta and Cstb.

The liquid crystal capacitors clca and Clcb are formed by using subpixel electrodes 191a and 191b and a common electrode 270 as two terminals and using the liquid crystal layer 3 interposed between the two terminals as a dielectric material.

The storage capacitors Csta and Cstb which perform an auxiliary role of the liquid crystal capacitors Clca and Clcb are formed by overlapping the storage electrode line SL and the subpixel electrodes 191a and 191b which are provided in the lower panel 100. An insulator is interposed therebetween. The storage electrode line SL is applied with a predetermined voltage, such as the common voltage Vcom.

The voltages charged in the two liquid crystal capacitors Clca and Clcb are set to have a slight difference from each other. For example, a data voltage applied to the liquid crystal capacitor Clca is set to be lower or higher than that applied to the liquid crystal capacitor Clcb adjacent thereto. When the voltage of the two liquid crystal capacitors Clca and Clcb is appropriately controlled as described above, an image viewed from the side of the liquid crystal display may approach an image viewed from the front of the liquid crystal display, thereby improving side visibility of the liquid crystal display.

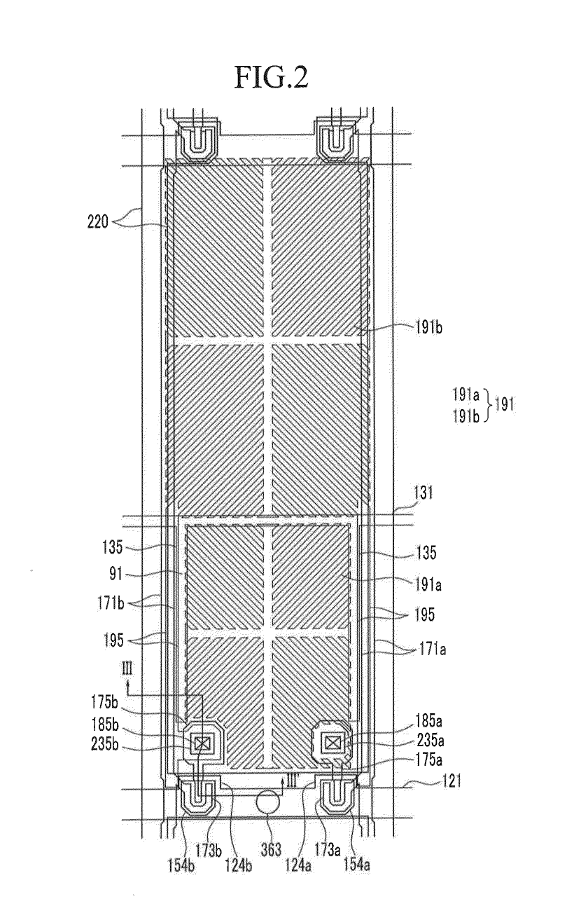

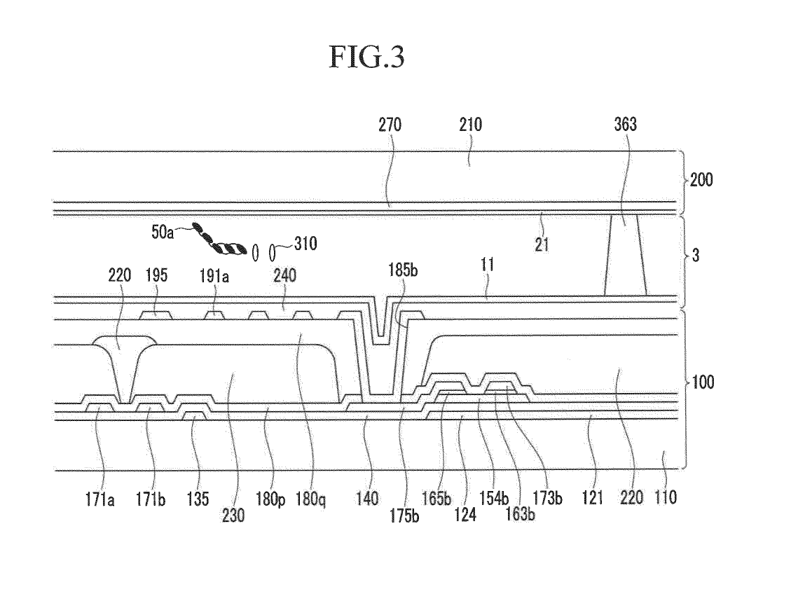

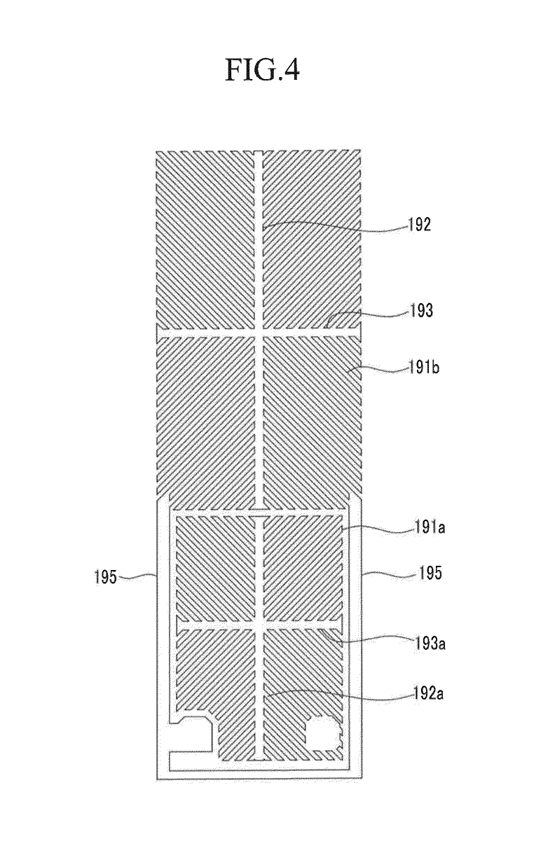

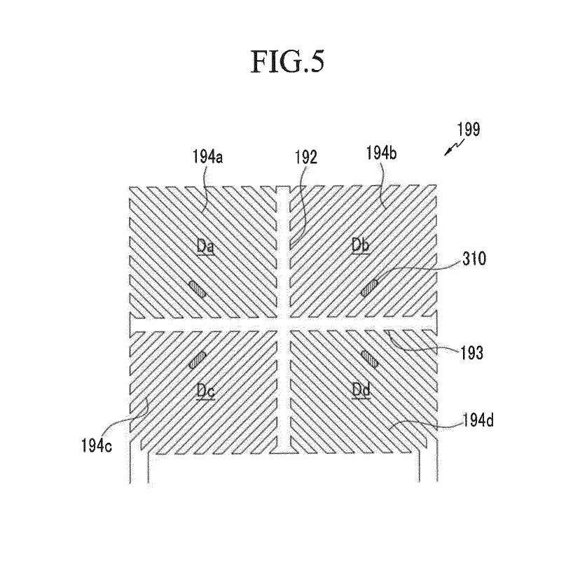

FIG. 2 is a layout view of a liquid crystal display according to an exemplary embodiment of the present invention, and FIG. 3 is a cross-sectional view taken along line III-III′ of FIG. 2. FIG. 4 is a top plan view of a pixel electrode according to an exemplary embodiment of the present invention. FIG. 5 is a top plan view of a basic electrode of the liquid crystal display according to an exemplary embodiment of the present invention.

Referring to FIGS. 2 and 3, the liquid crystal display includes a lower panel 100 and an upper panel 200 which face each other and the liquid crystal layer 3 interposed between the two display panels 100 and 200.

First, the lower panel 100 will be described.

A plurality of gate lines 121 and a plurality of storage electrode lines 131 and 135 are formed on an insulating substrate 110.

The gate lines 121 transfer gate signals and extend in a horizontal direction. Each of the gate lines 121 includes a first and second gate electrode 124a and 124b which protrude upwardly.

The storage electrode line includes a stem line 131 which extends in substantially parallel with the gate line 121 and a plurality of storage electrodes 135 which extends therefrom.

A shape and a disposition of the storage electrode lines 131 and 135 may be modified in various forms.

The gate insulating layer 140 is formed on the gate line 121, the storage electrode lines 131 and 135 and a plurality of semiconductors 154a and 154b. The semiconductors 154a and 154b may be formed of amorphous silicon, crystalline silicon, and the like, are formed on the gate insulating layer 140.

A plurality of pairs of ohmic contacts is formed on each of the semiconductors 154a and 154b. For example, a pair of ohmic contacts 165b is formed on the semiconductor layer 154b. The ohmic contacts may be formed of materials including, but are not limited to, silicide or n+ hydrogenated amorphous silicon doped with high-concentration n-type impurity.

A plurality of pairs of data lines 171a and 171b and a plurality of pairs of first and second drain electrodes 175a and 175b are formed on the ohmic contacts and the gate insulating layer 140.

The data lines 171a and 171b transfer the data signals and extend in a vertical direction to cross over the gate line 121 and the stem line 131 of the storage electrode line SL. The data lines 171a and 171b include first and second source electrodes 173a and 173b having a U-letter shape. The first and second source electrodes 173a and 173b protrude from the data lines 171a and 171b toward the first and second gate electrodes 124a and 124b so that the first and second source electrodes 173a and 173b face the first and second drain electrodes 175a and 175b. The first and second drain electrodes 175a and 175b include extended portions surround by the U-letter shape of the first and second source electrodes 173a and 173b.

For example, one end of the first drain electrode 175a and one end of the second drain electrode 175b each are partially enclosed with the first and second source electrodes 173a and 173b and extend upwardly. The other end of the first drain electrode 175a and the other end of the second drain electrode 175b have a wide area to be connected to contact holes 185a and 185b.

However, in addition to the first and second drain electrodes 175a and 175b, the shape and configuration of the data lines 171a and 171b may be changed in various forms.

The first and second gate electrodes 124a and 124b, the first and the second source electrodes 173a and 173b, and the first and the second drain electrodes 175a and 175b form first and second thin film transistors (TFTs) along with the first and second semiconductors 154a and 154b. Channels of the first and second thin film transistors are formed in the first and second semiconductors 154a and 154b between the first and second source electrodes 173a and 173b and the first and second drain electrodes 175a and 175b.

The ohmic contacts 163b and 165b are interposed between the semiconductors 154a and 154b which are beneath the ohmic contacts 163b and 165b and the data lines 171a and 171b, and are interposed between the semiconductors 154a and 154b which are beneath the ohmic contacts 163b and 165b and the drain electrodes 175a and 175b, thereby lowering a contact resistance therebetween. The semiconductors 154a and 154b include an exposed portion which is not covered with the data lines 171a and 171b and the drain electrodes 175a and 175b, between the source electrodes 173a and 173b and the drain electrodes 175a and 175b.

A lower passivation layer 180p made of silicon nitride, silicon oxide, or the like, is formed on the data lines 171a and 171b, the drain electrodes 175a and 175b, and the exposed portion of the semiconductors 154a and 154b.

A color filter 230 is formed on the lower passivation layer 180p. The color filter 230 may include three color filters of red, green, and blue. The color filter 230 may be formed of a single layer or a double layer made of chromium and chromium oxide. A light blocking member 220 made of an organic material is formed on the color filter 230. The light blocking member 220 may be arranged in a matrix form.

An upper passivation layer 180q made of a transparent organic insulating material is formed on the color filter 230 and the light blocking member 220. The upper passivation layer 180q prevents the color filter 230 from being exposed and provides a flat surface. A plurality of contact holes 185a and 185b exposing the first and second drain electrodes 175a and 175b is formed in the upper passivation layer 180q.

A plurality of pixel electrodes 191 is formed on the upper passivation layer 180q. The pixel electrodes 191 may be formed of a transparent conductive material including, but is not limited to, ITO (Indium Tin Oxide) or IZO (Indium Zinc Oxide) or may be formed of a reflective metal including, but is not limited to, aluminum, silver, chromium, or an alloy thereof.

Each pixel electrode 191 includes the first and second subpixel electrodes 191a and 191b spaced apart from each other, and each of the first and second subpixel electrodes 191a and 191b includes a basic electrode 199 illustrated in FIG. 5 or at least one modification thereof.

Next, referring to FIGS. 4 and 5, the basic electrode 199 will be described in detail.

As illustrated in FIG. 5, the basic electrode 199 is quadrangular and includes a horizontal stem part 193 and a vertical stem part 192 that cross each other. Further, the basic electrode 199 is divided into four regions by the horizontal and vertical stem parts 193 and 192. The four regions include a first sub-region Da, a second sub-region Db, a third sub-region Dc, and a fourth sub-region Dd. The sub-regions Da, Db, Dc, and Dd include a plurality of first to fourth fine branch parts 194a, 194b, 194c, and 194d, respectively.

The first sub-region Da includes a first fine branch part 194a obliquely extends left up from the horizontal stem part 193 or the vertical stem part 192. The second sub-region Db includes a second fine branch part 194b obliquely extends right up from the horizontal stem part 193 or the vertical stem part 192. The third sub-region Dc includes a third fine branch part 194c extends left down from the horizontal stem part 193 or the vertical stem part 192. The fourth sub-region Dd includes a fourth fine branch part 194d obliquely extends right down from the horizontal stem part 193 or the vertical stem part 192.

The first to fourth fine branch parts 194a, 194b, 194c, and 194d extend at an angle of about 45° or about 135° with respect to the gate line 121 or the horizontal stem part 193. Further, the fine branch parts 194a, 194b, 194c, and 194d of the two neighboring sub-regions Da, Db, Dc, and Dd may be orthogonal to each other.

A width of the fine branch parts 194a to 194d may be about 2.0 μm to about 5.0 m and an interval between the neighboring fine branch parts 194a to 194d within one of the sub-regions Da to Dd may be about 2.5 μm to about 5.0 μm.

Although not illustrated, as the fine branch parts 194a, 194b, 194c, and 194d are closer to the horizontal stem part 193 or the vertical stem part 192, the width of the fine branch parts 194a, 194b, 194c and 194d increases.

Referring again to FIGS. 2 to 5, the first and second subpixel electrodes 191a and 191b each include one basic electrode 199. In the pixel electrode 191, an area occupied by the second subpixel electrode 191b may be larger than an area occupied by the first subpixel electrode 191a. In this case, the size of the basic electrode 199 is such that the second subpixel electrode 191b is about 1.0 times to about 2.2 times larger than the area of the first subpixel electrode 191a.

The second subpixel electrode 191b includes a pair of branches 195 which extend along a data line 171 including the data lines 171a and 171b. The left branch 195 is disposed between the first subpixel electrode 191a and the data line 171a, and the right branch 195 is disposed between the first subpixel electrode 191a and the data line 171b. The branches 195 are connected at a lower end of the second subpixel electrode 191b. The first and second subpixel electrodes 191a and 191b are physically and electrically connected to the first and second drain electrodes 175a and 175b through the contact holes 185a and 185b. A data voltage is supplied to the first and second subpixel electrodes 191a and 191b from the first and second drain electrodes 175a and 175b.

An interval layer 240 is disposed on the pixel electrode 191. The interval layer 240 may be an insulating layer including an insulating material such as an inorganic compound or an organic compound.

The time constant τ of the liquid crystal layer 3 is represented as follows:

$$τ ∝ \frac{{d}^{2} \cdot }{k} ,$$

wherein γ represents a rotating viscosity of a liquid crystal and k represents an elastic coefficient. The time constant corresponds to a response speed of the liquid crystal molecules included in the liquid crystal layer 3. The time constant τ is reduced as a thickness d of the liquid crystal layer 3 is reduced, thereby increasing the response speed.

The thickness of the liquid crystal layer 3 may be referred to as a cell gap. The interval layer 240 reduces the cell gap while maintaining the distance between the pixel electrode 191 and the common electrode 270. For example, the sum of the thickness of the liquid crystal layer 3 and the thickness of the interval layer 240 corresponds to the distance between the pixel electrode 191 and the common electrode 270. Therefore, the interval layer 240 does not affect the distance between the electrodes forming an electric field while reducing the thickness of the liquid crystal layer 3. Accordingly, the effect of the fringe field is substantially the same, such that there is no substantial change in transmittance of the liquid crystal layer 3.

The refractive index of the interval layer 240 may range between about 1.6 and about 1.8. The refractive index of the interval layer 240 may have substantially the same as that of the pixel electrode 191. For example, the refractive index of a material, such as ITO, which forms the pixel electrode 191 may range from about 1.6 and about 1.8.

The interval layer 240 may be formed of an insulating material having a dielectric constant that is equal to or larger than a maximum value of a dielectric constant of a liquid crystal material of the liquid crystal layer 3. In this case, the capacitance of the interval layer 240 has such a magnitude that the effective voltage applied to the liquid crystal layer 3 may be substantially similar to the effective voltage applied to a liquid crystal layer having no the interval layer 240.

Next, the upper panel 200 will be described.

The common electrode 270 is formed on the transparent insulating substrate 210 in the upper panel 200.

A spacer 363 is provided to maintain an interval between the upper panel 200 and the lower panel 100.

Alignment layers 11 and 21 are disposed on the lower panel 100 and the upper panel 200 and may be a vertical alignment layer. The alignment layers 11 and 21 are a liquid crystal alignment layer including, but is not limited to, polyamic acid, or polyimide, or the like. The alignment layers 11 and 21 may include a first alignment polymer (not illustrated) which is formed by irradiating light to a first alignment aid.

A polarizer (not illustrated) may be provided outside the lower panel 100 and the upper panel 200.

The liquid crystal layer 3 is interposed between the lower panel 100 and the upper panel 200. The liquid crystal layer 3 includes a second alignment polymer 50a which is formed by irradiating light to a plurality of liquid crystals 310 and a second alignment aid.

The liquid crystals 310 have a negative dielectric anisotropy and a major axis thereof is aligned in a substantially vertical direction with respect to surfaces of the two display panels 100 and 200 if there is no electric field.

When a voltage is applied to the pixel electrode 191 and the common electrode 270, the major axis of the liquid crystals 310 rotates at an angle with respect to the electric field formed between the pixel electrode 191 and the common electrode 270.

When light is incident on the liquid crystal layer 3, the inclined angle of the liquid crystals 310 determines the degree of polarization of incident light and transmittance by the polarizer to display an image.

The inclined direction of the liquid crystals 310 is determined using the fine branches 194a, 194b, 194c, and 194d of the pixel electrode 191. When a voltage is applied to the pixel electrode 191 and the common electrode 270, the liquid crystals 310 are inclined toward a direction parallel with length directions of the fine branches 194a, 194b, 194c, and 194d. The one pixel electrode 191 includes four sub-regions Da, Db, Dc, and Dd in which the length directions of the fine branches 194a, 194b, 194c, and 194d are different from each other, and therefore the liquid crystals 310 are inclined toward approximately four directions. The liquid crystal layer 3 includes four domains. Each domain has an alignment direction different from other neighboring domains. As described above, the direction in which the liquid crystal is inclined is various, and thus the viewing angle of the liquid crystal display may be increased.

The first alignment polymer (not illustrated) and the second alignment polymer 50a which are formed by the polymerization of the first alignment aid and the second alignment aid and serve to control the pretilt angle of an initial alignment direction of the liquid crystals 310. The first alignment aid and the second alignment aid may include a reactive mesogen.

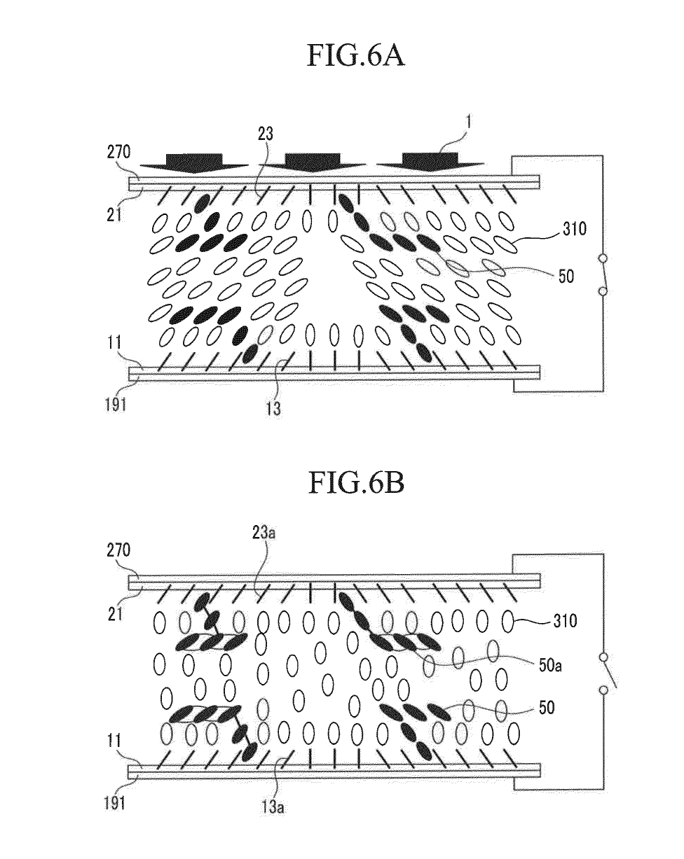

The first alignment aid and the second alignment aid may be polymerized by light, which will be described with reference to FIGS. 6A and 6B along with FIGS. 2 to 5.

FIGS. 6A and 6B are schematic diagrams illustrating a method of forming a pretilt of a liquid crystal by using the alignment aid according to an exemplary embodiment of the present invention.

First, the thin film transistor array panel 100 and the common electrode panel 200 are each manufactured.

The lower panel 100 is manufactured by the following method.

Referring to FIGS. 2, 3 6A and 6B, the gate line 121 including the gate electrodes 124a and 124b, the gate insulating layer 140, the semiconductors 154a and 154b, the data lines 171a and 171b including the source electrodes 173a and 173b, the drain electrodes 175a and 175b, and the lower passivation layer 180p are sequentially formed on the substrate 110 by stacking and patterning a plurality of thin films.

Next, the color filter 230 is formed on the lower passivation layer 180p and the light blocking member 220 for blocking light leakage is formed on the color filter 230. The upper passivation layer 180q is formed on the light blocking member 220 and the color filter 230.

As illustrated in FIGS. 4 and 5, the pixel electrode 191 which includes the vertical part 192, the horizontal part 193, and the plurality of fine branches 194a, 194b, 194c, and 194d extending therefrom is formed on the upper passivation layer 180q by stacking and patterning a conductive layer of ITO, IZO, or the like.

Next, the interval layer 240 is formed on the pixel electrode 191 and the alignment layer 11 including the first alignment aid is applied thereon.

The upper panel 200 is manufactured by the following method.

The common electrode 270 is formed on the substrate 210. Next, the alignment layer 21 including the first alignment aid is deposited on the common electrode 270.

Next, the liquid crystal layer 3 is formed by assembling the lower panel 100 and the upper panel 200 manufactured by the above-mentioned method and injecting a mixture of the liquid crystal 310 and the above-mentioned second alignment aid therebetween. Alternatively, the liquid crystal layer 3 may be formed by a method of dripping a mixture of the liquid crystal 310 and the second alignment aid on the lower panel 100 or the upper panel 200.

Next, referring to FIGS. 6A and 5, a voltage is applied to the pixel electrode 191 and the common electrode 270. The application of voltage causes the first alignment aids 13 and 23 included in the alignment layers 11 and 21 to have pretilt angles. Further, the liquid crystal 310 and the second alignment aid 50 are inclined to a direction parallel with the length directions of the fine branches 194a to 194d of the pixel electrode 191.

As described above, light 1 is irradiated when a voltage is applied between the pixel electrode 191 and the common electrode 270. The light 1 may have a wavelength to polymerize the first alignment aids 13 and 23 and the second alignment aids 50. For example, the light 1 may include ultraviolet rays.

Referring to FIG. 6B, the first alignment polymers 13a and 23a are formed by polymerizing the first alignment aids 13 and 23 extending from the alignment layers 11 and 21 using the irradiation of light. The second alignment polymer 50a is formed by photo-polymerizing a group of the second alignment aids 50 which are adjacent to each other. The first alignment polymers 13a and 23a and the second alignment polymer 50a are arranged along the alignment of the liquid crystal, and even after the applied voltage is removed, the arrangement thereof is maintained so that the pretilt of the liquid crystal 310 is controlled.

Alternatively, at least one of the alignment layers 11 and 21 and the liquid crystal layer 3 may include alignment polymers.

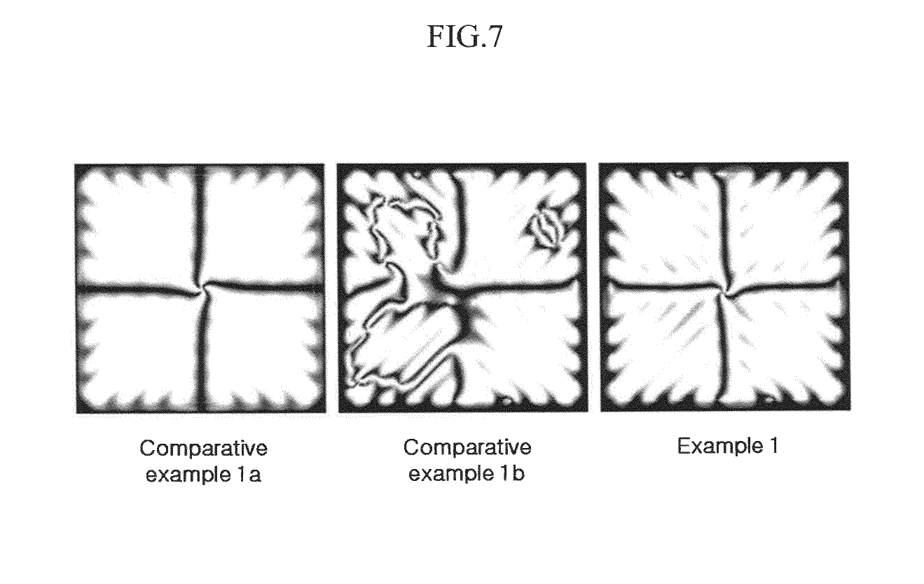

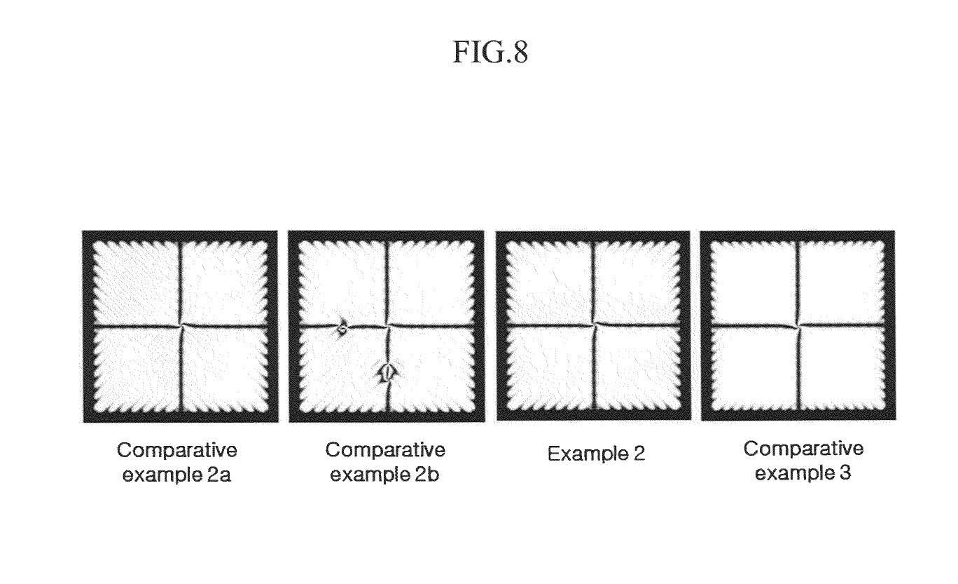

FIGS. 7 and 8 are photographs of screens driven by a liquid crystal display according to an exemplary embodiment of the present invention.

In FIG. 7, Comparative Example 1a is a screen when a liquid crystal display has the cell gap of about 3.2 μm, and Comparative Example 1b is a screen when a liquid crystal display has the cell gap of about 2.6 μm. The liquid crystal display of Comparative Example 1a has a configuration substantially similar to that of Comparative Example 1b. Compared to Comparative Example 1a, Comparative Example 1b having the narrower cell gap has smaller transmittance due to a texture severely occurring. Example 1 is the case of a liquid crystal display according to an exemplary embodiment of the present invention, and is a screen when a liquid crystal display has the cell gap of about 2.6 which is substantially similar to the cell gap of Comparative Example 1b. Referring to Example 1, there is little occurrence of the texture shown as in Comparative Example 1b even when the cell gap is reduced.

In FIG. 8, Comparative Example 2a is a screen when a liquid crystal display has the cell gap of about 3.2 μm and the patterned pixel electrode having a pitch of about 7 μm. Comparative Example 2b has the cell gap of about 3.0 μm. The liquid crystal display of Comparative Example 2a has a configuration substantially similar to that of Comparative Example 2b, except for the cell gap. Referring to Comparative Example 2a and Comparative Example 2b, when the cell gap is reduced, the texture occurs and thus the transmittance is reduced.

Comparative Example 3 has the cell gap of about 3.0 μm and the pixel electrode having about 6 μm. The liquid crystal display of Comparative Example 3 has a configuration substantially similar to that of Comparative Example 2b, except for the pitch. Referring to Comparative Example 3, even when the cell gap is reduced, the influence of the fringe field is reduced by reducing the pitch of the pixel electrode, thereby preventing the transmittance from being reduced due to the texture. Example 2 is the case of a liquid crystal display according to an exemplary embodiment of the present invention. The liquid crystal display of Example 2 has the cell gap of 3.0 μm substantially similar to the cell gap of Comparative Example 2b. Referring to Example 2, similar to Comparative Example 3, there is little occurrence of the texture even when the cell gap is reduced.

Herein, the pitch of the pixel electrode is defined as the value obtained from summing the width of the fine branch part and the interval between the neighboring fine branch parts which are formed in the pixel electrode.

While the present invention has been shown and described with reference to exemplary embodiments thereof, it will be apparent to those of ordinary skill in the art that various changes in form and detail may be made therein without departing from the spirit and scope of the present invention as defined by the following claims.

What is claimed is:

1. A liquid crystal display, comprising:
a lower substrate;
a first electrode disposed on the lower substrate;
an interval layer disposed on the first electrode;
an upper substrate;
a second electrode disposed on the upper substrate and facing the lower electrode; and
a liquid crystal layer interposed between the interval layer and the second electrode, the liquid crystal layer comprising a liquid crystal material,
wherein the first electrode comprises patterned electrodes.

2. The liquid crystal display of claim 1, wherein a sum of a thickness of the liquid crystal layer and a thickness of the interval layer corresponds to a distance between the first electrode and the second electrode.

3. The liquid crystal display of claim 2, wherein the interval layer comprises an insulating material.

4. The liquid crystal display of claim 3, wherein the first electrode comprises a fine slit-shaped electrode and the second electrode comprises a plate-shaped electrode.

5. The liquid crystal display of claim 4, wherein the first electrode comprises a cross stem part which comprises a horizontal stem part and a vertical stem part intersecting the horizontal stem part and the cross stem part is comprised in a unit pixel region.

6. The liquid crystal display of claim 5, wherein the first electrode comprises a plurality of fine branch parts extending in different directions from the horizontal and the vertical stem parts.

7. The liquid crystal display of claim 1, wherein the first electrode comprises a transparent conductive material.

8. The liquid crystal display of claim 7, wherein the interval layer comprises an insulating material and has a refractive index ranging about 1.6 and about 1.8.

9. The liquid crystal display of claim 8, wherein the refractive index of the interval layer is substantially the same as that of the first electrode.

10. The liquid crystal display of claim 1, wherein a dielectric constant of the interval layer is substantially equal to or larger than that of the liquid crystal material.

11. The liquid crystal display of claim 1, wherein a major axis of the liquid crystal material is aligned in a direction substantially vertical to the upper substrate or the lower substrate if no electric field between the first electrode and the second electrode is applied.

12. The liquid crystal display of claim 1, wherein the liquid crystal material has a negative dielectric anisotropy.

13. The liquid crystal display of claim 1, further comprising:
a color filter disposed between the lower substrate and the first electrode.

14. The liquid crystal display of claim 1, further comprising:
an alignment layer disposed between the interval layer and the liquid crystal layer.

15. The liquid crystal display of claim 14, wherein at least one of the alignment layer and the liquid crystal layer includes an alignment polymer.

16. The liquid crystal display of claim 1, further comprising a thin film transistor formed on the lower substrate and configured to provide a data voltage to the first electrode.

17. A liquid crystal display comprising a plurality of pixels, at least one pixel comprising:
a first electrode comprising repetitively patterned electrodes and disposed on a lower substrate;
an interval layer covering the first electrode;
a second electrode disposed on an upper substrate and facing the lower electrode;
a pair of alignment layers disposed on inner surfaces defined between the second electrode and the interval layer; and
a liquid crystal layer comprising a plurality of liquid crystal molecules and interposed between the pair of alignment layers,
wherein a data voltage is supplied to the first electrode and a common voltage is supplied to the second electrode to generate an electric field between the first electrode and the second electrode.

18. The liquid crystal display of claim 17, wherein the interval layer is formed of an insulating material, wherein a dielectric constant of the interval layer is substantially equal to or larger than a dielectric constant of the liquid crystal layer.

19. The liquid crystal display of claim 17, wherein the repetitively patterned electrodes of the first electrode is grouped into at least two groups according to an direction along which patterned electrodes are extended, wherein a first group of the at least two groups has a first direction and a second group of the at least two groups has a second direction substantially perpendicular to the first direction.

20. The liquid crystal display of claim 17, wherein at least one of the liquid crystal layer and the alignment layers includes alignment polymers.
